(19) United States
(12) Patent Application Publication
(10) Pub. No.: US 2024/0283484 A1
(43) Pub. Date: Aug. 22, 2024

(54) SYSTEMS AND METHODS FOR EXECUTING NEAR_FIELD COMMUNICATION (NFC) TRANSACTIONS USING A USER DEVICE

(71) Applicant: SAMSUNG ELECTRONICS CO., LTD., Suwon-si (KR)

(72) Inventors: Himanshu KUMAR, Bengaluru (IN); Vivekanandan SREENIVASAN, Bengaluru (IN); Pavan Kumar PANAKALAPATI, Bengaluru (IN)

(73) Assignee: SAMSUNG ELECTRONICS CO., LTD., Suwon-si (KR)

(21) Appl. No.: 18/434,182

(22) Filed: Feb. 6, 2024

Related U.S. Application Data
(63) Continuation of application No. PCT/KR2024/000515, filed on Jan. 11, 2024.

(30) Foreign Application Priority Data
Feb. 22, 2023 (IN) 202341012110
Jul. 5, 2023 (IN) 202341012110

(51) Int. Cl. H04B 5/20; H04B 5/43

(52) U.S. Cl. CPC H04B 5/20; H04B 5/43

(57) ABSTRACT

A method of controlling an electronic device executing near-field communication (NFC) transactions, may include: obtaining a plurality of context parameters related to an NFC transaction to be performed; identifying an optimal radio frequency (RF) configuration from a plurality of RF configurations for executing the NFC transaction by inputting the plurality of context parameters into an artificial intelligence (AI) model; and executing the NFC transaction using the optimal RF configuration. The AI model may be configured to establish correlations of the plurality of context parameters with the plurality of RF configurations.

### CROSS-REFERENCE TO RELATED APPLICATIONS

This application is a bypass continuation of an International application No. PCT/KR2024/000515, filed on Jan. 11, 2024, which is based on and claims the benefit of an Indian Provisional Specification patent application number 202341012110, filed on Feb. 22, 2023, in the Indian Intellectual Property Office, and of an Indian Complete Specification patent application number No. 202341012110, filed on Jul. 5, 2023, in the Indian Intellectual Property Office, the disclosure of each of which is incorporated by reference herein in its entirety.

### BACKGROUND

### 1. Field

The disclosure generally relates to the field of Near Field Communication (NFC). Specifically, the disclosure relates to methods and systems for executing NFC transactions based on context based reconfigurable configurations to improve NFC transaction efficiency.

### 2. Description of Related Art

Mobile contactless transactions have become increasingly popular recently due to their convenience. In the future, a majority of people will be using contactless transactions with smart devices such as smartwatches, bracelets, Near Field Communication (NFC) rings, and the like. NFC is a set of communication protocols based on Radio Frequency Identification (RFID). Through NFC, two devices can communicate with each other when they are within a predefined range, such as 4 cm or less. The use cases for NFC based contactless transactions vary by demography and user preferences. An example use case of NFC based contactless transactions is shown in FIG. 1A (related art), in which users may use a device 100 for carrying out contactless transactions. As seen in FIG. 1A, the device 100 may be used for a variety of applications such as door keys, transit cards, payments, gym equipment usage, etc. . . . by way of their respective readers.

The device 100 may be pre-configured to support various application uses. However, the device 100 may have reduced capability compared to other devices, such as smartphones. As an example, the device 100 may be a smartwatch, however, NFC antennas in the device 100 may have reduced capability as compared to existing smartphones. This reduced capability makes it difficult for a successful transaction with different applications and/or readers.

Further, contactless transactions are carried out using NFC antennas having radio frequency (RF) configuration to support contactless features (e.g., contactless payments/transactions). In related methods, such as for the device 100, there is a single static tuned RF configuration for the NFC antenna of the device 100. As seen in FIG. 1B, a static RF configuration 102 is loaded as per a device model of the device 100, in accordance with related art. The single RF configuration 102, say version (26, C1) is tuned in such a way as to support the various NFC applications for a geographical region, however, with varied success rates.

Using a single static RF configuration in different scenarios may result in one or more failed transactions. Two such example scenarios depicting reasons for transaction failure using the single static RF configuration have been shown in FIGS. 2A and 2B, in accordance with related art. As seen in FIG. 2A, the static RF configuration 102 of the device 100 may be used for transit pass application 104 as well as for door key application 106. The RF configuration 102 may be suitable for the transit pass application 104. However, for the door key application 106, the RF configuration 102 may have a lower success rate. Accordingly, NFC transactions related to transit pass application 104 may be successful and NFC transactions related to door key application 106 may be unsuccessful.

As seen in FIG. 2B, a user 108 may purchase the device 100 in a first geographical region. The user 108 may go to an establishment 110 and carry out a contactless transaction at a Point of Sale (POS) reader 112 at the establishment 110 within the first geographical region. The device 100 has the single static RF configuration which may be used for successful transactions with the POS reader 112. The user 108 may travel to a second geographical region and carry out a contactless transaction using the device 100, such as a transit pass 114 in the second geographical region. However, the transaction may fail for the transit pass in the second geographical region.

It is evident from FIGS. 2A and 2B that the related methods have multiple shortcomings. For instance, static RF configuration is loaded onto a device for a particular model, and aligning the RF configuration to suit all compatible NFC features may be cumbersome. Further, region specific NFC applications may require customized RF configuration. Moreover, users may wear the devices in the left or right hand as per their preference, which causes a change in antenna position, leading to an increase in failure rates of transactions.

Therefore, there is a desire for an improved method and system in order to solve the above-mentioned problems. For instance, there is a desire for systems and methods which enhance success rates of NFC transactions and enhance user experience.

### SUMMARY

This summary is provided to introduce a selection of concepts, in a simplified format, that are further described in the detailed description of the disclosure. This summary is neither intended to identify key or essential inventive concepts of the disclosure and nor is it intended for determining the scope of the disclosure.

According to an aspect of one or more example embodiments, a method of controlling an electronic device executing near-field communication (NFC) transactions, may include: obtaining a plurality of context parameters related to an NFC transaction to be performed; identifying an optimal radio frequency (RF) configuration from a plurality of RF configurations for executing the NFC transaction by inputting the plurality of context parameters into an artificial intelligence (AI) model; and executing the NFC transaction using the optimal RF configuration. The AI model may be configured to establish correlations of the plurality of context parameters with the plurality of RF configurations.

According to an aspect of one or more example embodiments, an electronic device executing near-field communication (NFC) transactions may include: at least one memory storing instructions; and at least one processor connected to the at least one memory and configured to execute the instructions to: obtain a plurality of context parameters related to an NFC transaction to be performed; identify an optimal radio frequency (RF) configuration from a plurality of RF configurations for executing the NFC transaction by inputting the plurality of context parameters into an artificial intelligence (AI) model; and execute the NFC transaction using the optimal RF configuration. The AI model may be configured to establish correlations of the plurality of context parameters with the plurality of RF configurations.

To further clarify the advantages and features of the disclosure, a more particular description of the disclosure will be rendered by reference to specific embodiments thereof, which is illustrated in the appended drawings. It is appreciated that these drawings depict only typical embodiments of the disclosure and are therefore not to be considered limiting of its scope. The disclosure will be described and explained with additional specificity and detail with the accompanying drawings.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1A illustrates an example use case of NFC based contactless transactions, in accordance with related art.

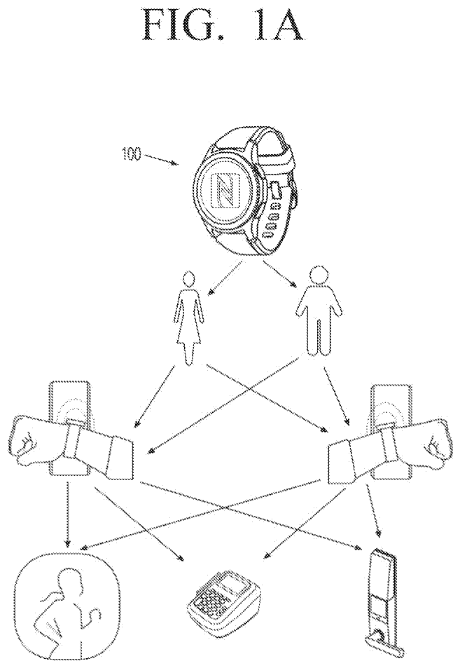

FIG. 1B illustrates an example of a static RF configuration in a device, in accordance with related art.

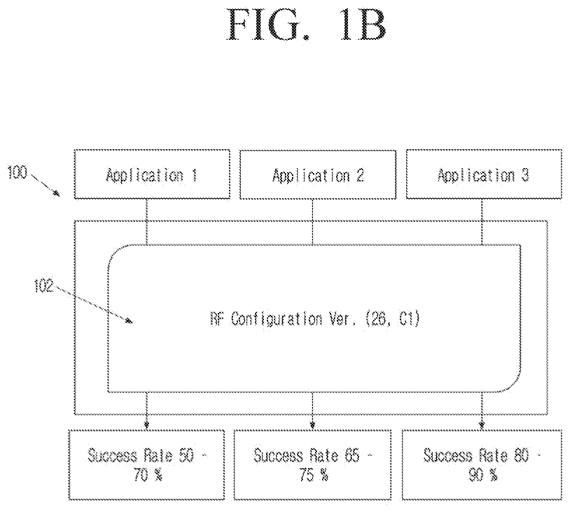

FIG. 2A illustrates example scenarios depicting reasons for transaction failure using a single static RF configuration, in accordance with related art.

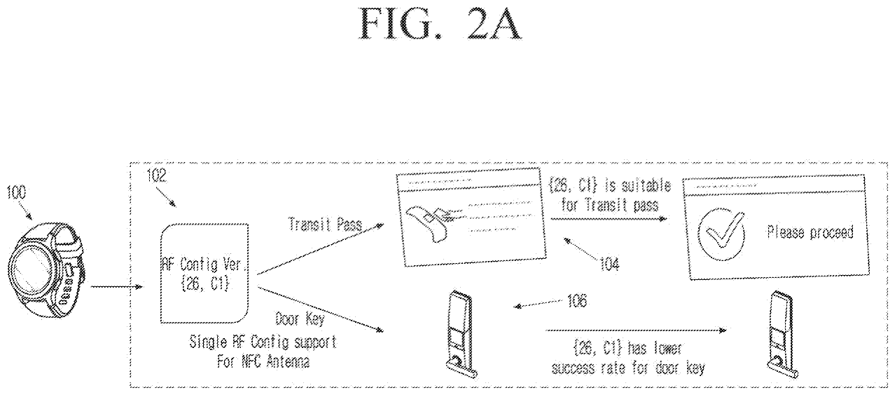

FIG. 2B illustrates example scenarios depicting reasons for transaction failure using a single static RF configuration, in accordance with related art.

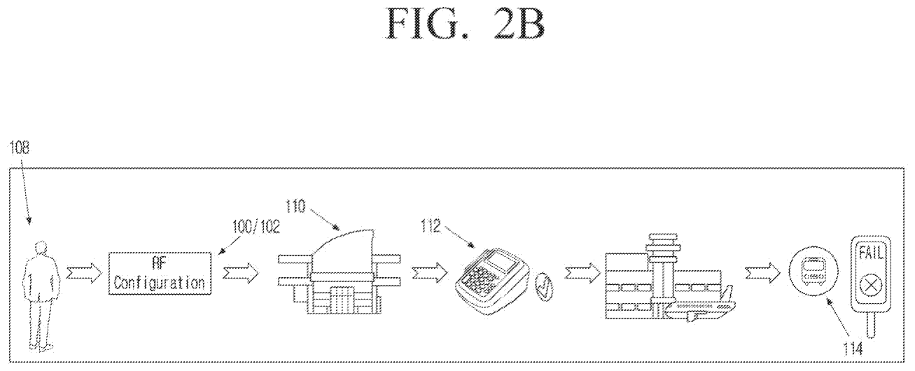

FIG. 3 illustrates a schematic block diagram of an environment for executing NFC transactions, according to one or more embodiments of the disclosure.

FIG. 4 illustrates schematic block diagrams of the user device and the system for executing NFC transactions, according to one or more embodiments of the disclosure.

FIG. 5 illustrates a schematic block diagram of one or more modules for executing NFC transactions based on context-based reconfigurable RF configurations, according to one or more embodiments of the disclosure.

FIG. 6 illustrates a schematic overview of the system, according to one or more embodiments of the disclosure, according to one or more embodiments of the disclosure.

FIG. 7 illustrates a process flow for selecting a model derived configuration during run time of the user device, according to one or more embodiments of the disclosure.

FIG. 8 illustrates a process flow for executing an NFC transaction with a user device in real time, according to one or more embodiments of the disclosure.

FIG. 9A illustrates an example process flow comprising a method for executing NFC transactions using the user device, according to one or more embodiments of the disclosure.

FIG. 9B illustrates an example process flow comprising a method for training an artificial intelligence (AI) model, according to one or more embodiments of the disclosure.

FIG. 9C illustrates an example process flow comprising a method for selecting optimal RF configuration based on the AI model, according to one or more embodiments of the disclosure.

FIG. 10 illustrates various use cases for executing NFC transactions based on context-based reconfigurable RF configurations, according to one or more embodiments of the disclosure.

FIG. 11 illustrates various use cases for executing NFC transactions based on context-based reconfigurable RF configurations, according to one or more embodiments of the disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the disclosure. Furthermore, in terms of the construction of the device, one or more components of the device may have been represented in the drawings by conventional symbols, and the drawings may show only those specific details that are pertinent to understanding the embodiments of the disclosure so as not to obscure the drawings with details that will be readily apparent to those of ordinary skill in the art having the benefit of the description herein.

### DETAILED DESCRIPTION

For the purpose of promoting an understanding of the principles of the disclosure, reference will now be made to the various embodiments and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are explanatory of the disclosure and are not intended to be restrictive thereof.

Reference throughout this specification to “an aspect”, “another aspect” or similar language means that a particular feature, structure, or characteristic described in connection with the embodiment is included in at least one embodiment of the disclosure. Thus, appearances of the phrase “in one or more embodiments”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components. As used herein, an expression “at least one of” preceding a list of elements modifies the entire list of the elements and does not modify the individual elements of the list. For example, an expression, “at least one of a, b, and c” should be understood as including only a, only b, only c, both a and b, both a and c, both b and c, or all of a, b, and c. Herein, when a term “same” or “equal” is used to compare a dimension of two or more elements, the term may cover a “substantially same” or “substantially equal” dimension.

The disclosure is directed towards a method and system for executing NFC transactions using context-based reconfigurable RF configurations. The term ‘transactions’ as used in the disclosure refers to an exchange of signals between a reader and a device comprising an antenna enabled for NFC, for multiple applications such as applications associated with vehicle cards, door cards, financial payments, transmit cards, and the like.

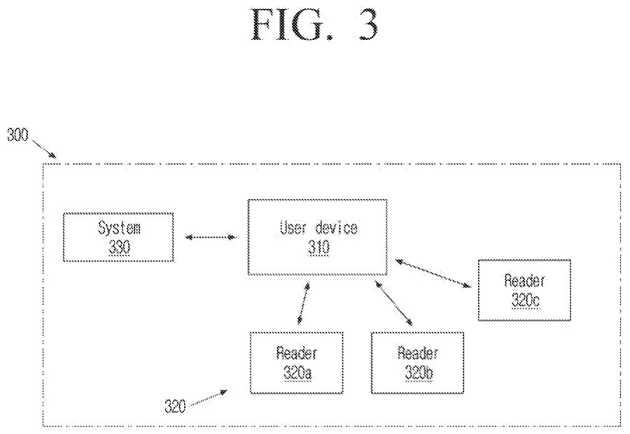

FIG. 3 illustrates a schematic block diagram of an environment 300 for executing NFC transactions. The environment 300 may comprise a user device 310 and multiple readers 320a, 320b, 320c (collectively referred to as ‘320’). The environment 300 may further comprise a system 330 configured to execute NFC transactions in conjunction with the user device 310 and the readers 320. In some embodiments, the user device 310 may be a wearable device, such as, a smartwatch, bracelet, ring, and other wearable device. In some embodiments, the readers 320 may be POS devices, payment terminals, NFC readers, door key readers, transmit terminal readers, and the like. In some embodiments, the user device 310 and the readers 320 may be positioned at a predetermined distance, such as about 4 cm, so as to perform the NFC transactions. In some embodiments, the user device 310 may communicate with the readers 320 via RF protocols.

In some embodiments, the system 330 may be an on-device system configured to cause NFC transactions through the user device 310. In some embodiments, the user device 310 may comprise the system 330 integrated therein.

In some embodiments, the system 330 may be distributed. For example, one or more components and/or functionalities of the system 330 may be provided though the user device 310, and one or more components and/or functionalities of the system 330 may be provided through a cloud-based unit (such as a cloud storage or a cloud-based server). In such embodiments, the system 330 may be communicatively coupled to user device 310 via a communication network.

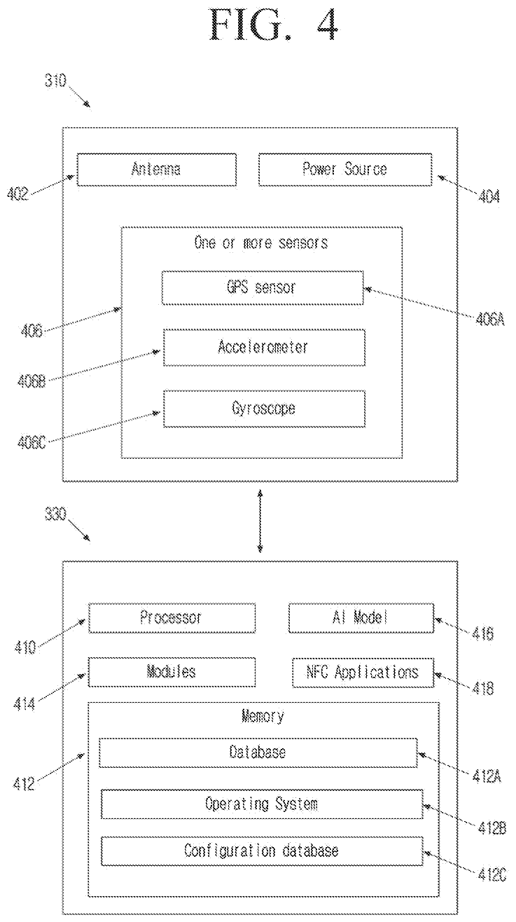

FIG. 4 illustrates schematic block diagrams of the user device 310 and the system 330 for executing NFC transactions, according to one or more embodiments of the disclosure.

In some embodiments, the user device 310 may comprise an antenna 402 configured to facilitate NFC communication with the readers 320. The user device 310 may comprise a power source 404 configured to provide operational power to the antenna 402. The antenna 402 may be referred to as an NFC antenna. The user device 310 may further comprise one or more sensors 406 configured to sense a plurality of context parameters associated with the user device 310 and/or a user associated with the user device 310. In some embodiments, the sensors 406 may comprise a GPS sensor 406A, an accelerometer 406B, and a gyroscope 406C.

In some embodiments, the system 330 may comprise a processor/controller 410 (referred as ‘processor 410’ hereinafter), a memory 412, one or more modules 414, an artificial intelligence (AI) model 416, and one or more NFC applications 418. In some embodiments, the AI model 416 may be included within the memory 412. In some embodiments, the AI model 416 may be included within the one or more modules 414. In some embodiments, the one or more modules 414 may be included within the memory 412.

In some embodiments, the NFC applications 418 may include software applications associated with vehicle cards, door cards, financial payments, transmit cards, and the like. In some embodiments, the memory 412 may be communicatively coupled to the a processor 410. The memory 412 may be configured to store data, and instructions executable by the processor 410. The memory 412 may include a database 412A configured to store data. The one or more modules 414 may include a set of instructions that may be executed to cause the system 330 to perform any one or more of the methods disclosed herein. The one or more modules 414 may be configured to perform the steps of the disclosure using the data stored in the database 412A to facilitate NFC transactions, as discussed throughout this disclosure. In one or more embodiments, each of the one or more modules 414 may be hardware units that may be outside the memory 412. Further, the memory 412 may include an operating system 412B for performing one or more tasks of the system 330, as performed by a generic operating system in the communications domain. Each of the one or more modules 414 may be physically implemented by analog and/or digital circuits including one or more of a logic gate, an integrated circuit, a microprocessor, a microcontroller, a memory circuit, a passive electronic component, an active electronic component, and the like.

The memory 412 may include a configuration database 412C configured to store a plurality of RF configurations. In some embodiments, the plurality of RF configurations may relate to NFC antenna configurations, in that, each of the plurality of RF configurations may comprise a corresponding NFC antenna configuration. In some embodiments, each of the corresponding NFC antenna configurations may be associated with one or more of radio frequency parameters, impedance parameters, NFC firmware information, and hardware configuration parameters of the user device 310.

The (at least one) memory 412 may be operable to store instructions executable by the (at least one) processor 410. The functions, acts, or tasks illustrated in the figures or described may be performed by the programmed processor 410 for executing the instructions stored in the memory 412. The functions, acts, or tasks are independent of the particular type of instructions set, storage media, processor, or processing strategy and may be performed by software, hardware, integrated circuits, firmware, micro-code, and the like, operating alone or in combination. Likewise, processing strategies may include multiprocessing, multitasking, parallel processing, and the like.

In some embodiments, the user device 310 may include a transceiver and an I/O interface. The I/O interface may provide a display function and one or more physical buttons on the user device 310. For the sake of brevity, the architecture and standard operations of operating system 412B, memory 412, database 412A, and processor 410 are not discussed in detail. In at least one embodiment, the database 412A may be configured to store the information as required by the one or more modules 414 and processor 410 to perform one or more functions to execute NFC transactions based on context parameters. In some embodiments, the I/O interface may be configured to receive a user input and facilitate execution of NFC transactions based on the user input.

In some embodiments, the memory 412 may communicate via a bus within the system 330. The memory 412 may include, but is not limited to, a non-transitory computer-readable storage medium, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In at least one example, the memory 412 may include a cache or random-access memory for the processor. In alternative examples, the memory 412 is separate from the processor/controller, such as a cache memory of a processor, the system memory, or other memory.

Further, the disclosure contemplates a computer-readable medium that includes instructions or receives and executes instructions responsive to a propagated signal, so that a device connected to a network may communicate voice, video, audio, images, or any other data over a network. Further, the instructions may be transmitted or received over the network via a communication port or interface or using a bus. The communication port or interface may be a part of the processor 410 or maybe a separate component. The communication port may be created in software or maybe a physical connection in hardware. The communication port may be configured to connect with a network, external media, the display, or any other components in system, or combinations thereof. The connection with the network may be a physical connection, such as a wired Ethernet connection or may be established wirelessly. Likewise, the additional connections with other components of the system 330 may be physical or may be established wirelessly. The network may alternatively be directly connected to the bus.

In at least one embodiment, the processor 410 may include specialized processing units such as, integrated system (bus) controllers, memory management control units, floating point units, graphics processing units, digital signal processing units, etc. In at least one embodiment, the processor 410 may include a central processing unit (CPU), a graphics processing unit (GPU), or both. The processor 410 may be one or more general processors, digital signal processors, application-specific integrated circuits, field-programmable gate arrays, servers, networks, digital circuits, analog circuits, combinations thereof, or other now known or later developed devices for analyzing and processing data. The processor 410 may implement a software program, such as code generated manually (e.g., programmed).

The processor 410 may be in communication with one or more input/output (I/O) devices via an I/O interface. The I/O interface may employ communication code-division multiple access (CDMA), high-speed packet access (HSPA+), global system for mobile communications (GSM), long-term evolution (LTE), WiMax, or the like.

The processor 410 may be in communication with a communication network via a network interface. The network interface may be the I/O interface. The network interface may connect to a communication network. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network may include, without limitation, a direct interconnection, local area network (LAN), wide area network (WAN), wireless network (e.g., using Wireless Application Protocol), the Internet, etc. The network interface may employ connection protocols including, but not limited to, direct connect, Ethernet (e.g., twisted pair 10/100/1000 Base T), transmission control protocol/internet protocol (TCP/IP), token ring, IEEE 802.11a/b/g/n/x, etc.

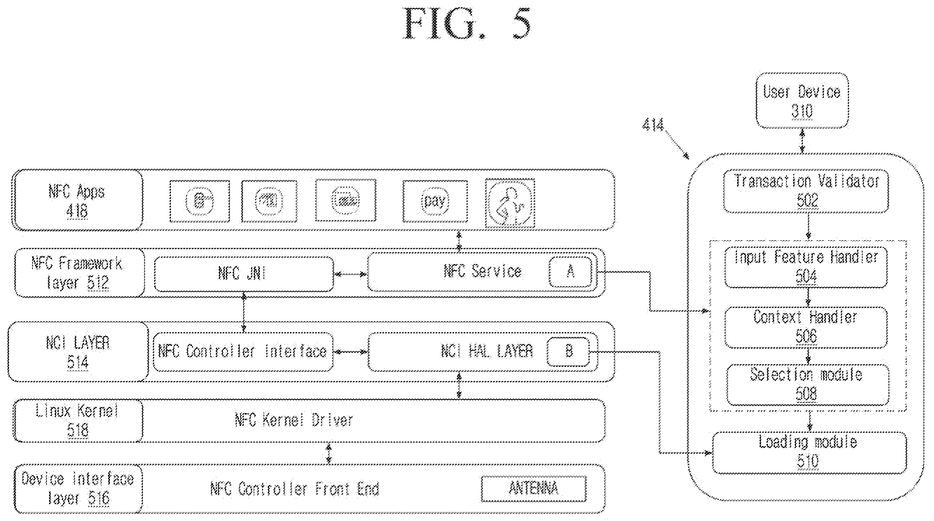

FIG. 5 illustrates a schematic block diagram of the one or more modules 414 of the system 330 for executing NFC transactions based on context-based reconfigurable RF configurations. In at least one embodiment, the one or more modules 414 may include a transaction validator 502, an input feature handler 504, a context handler 506, a selection module 508, and a loading module 510. Further, one or more modules 414 perform their designated functions in conjunction with the memory 412 and the AI model 416. The detailed explanation of each of the modules 414 is discussed in conjunction with FIG. 4 hereinafter.

In some embodiments, the one or more modules 414 may be communicatively coupled with other components of the system 330, such as, the processor 410, memory 412, the AI model 416, and the NFC applications 418. The one or more modules 414 may further be coupled to the user device 310, in particular, the one or more sensors 406 of the user device 310.

In some embodiments, the one or more modules 414 may be associated with one or more layers, such as, NFC framework layer 512 and NFC controller interface (NCI) layer 514. In some embodiments, a device interface layer 516 may be provided which may be associated with the antenna 402 and an NFC controller front end. Further, a Linux kernel layer 518 may be provided which may be associated with an NFC kernel driver. Further, the NCI layer 514 may be associated with NFC controller interface and NCI hardware abstraction layer (HAL) layer. In some embodiments, the NCI HAL layer may be associated with the loading module 510. Further, the NFC framework layer 512 may be associated with the NFC java native interface (JNI) and NFC service. In some embodiments, the NFC service may be associated with the input feature handler 504, the context handler 506, and the selection module 508. Further, the NFC framework layer 512 may be in communication with the NFC applications 418.

In some embodiments, the processor 410 may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU).

Referring to FIG. 4 and FIG. 5, the processor 410 may be configured to obtain a plurality of context parameters related to an NFC transaction to be performed. The processor 410 may be configured to obtain the plurality of context parameters in conjunction with the input feature handler 504. The processor 410 may be configured to obtain the plurality of context parameters from the one or more sensors 406 of the user device 310.

In some embodiments, the processor 410 may be configured to receive, from the one or more sensors 406, readings indicative of values of corresponding context parameters of the plurality of context parameters. In some embodiments, the plurality of context parameters may include an orientation of the user device 310, a tap angle of the user device 310 with respect to an NFC reader (such as readers 320), a key position of the user device 310, a type of the NFC transaction to be performed, NFC firmware information, and a geographic location where the NFC transaction is to be performed.

It is to be noted herein that the antenna 402 may be positioned at a specific location within the user device 310. In some embodiments, an orientation of the user device 310 may refer to the orientation of the user device 310 when worn by the associated user. For instance, the user device 310 may be a watch and the orientation may refer to whether the watch is worn on left hand or right wrist of the associated user. The orientation of the user device 310 may thus affect the position of the antenna 402 with respect to the readers 320. In some embodiments, the orientation of the user device 310 may be dynamic, in that, the orientation may change as per preferences of the associated user.

In some embodiments, the tap angle of the user device 310 may refer to an angle between the user device 310 and the readers 320, for instance, when an NFC transaction is being carried out. For instance, the tap angle may be 0 degrees, 60 degrees, 90 degrees, and any other suitable value. The tap angle may also affect the position of the antenna 402 with respect to the readers 320. In some embodiments, the tap angle of the user device 310 may be dynamic, in that, the tap angle may change as per preferences of the associated user while carrying out the NFC transaction.

In some embodiments, a key position of the user device 310 may refer to position of one or more physical keys of the user device 310, such as, a home key or a crown key. The key position may also affect the position of the antenna 402 with respect to the readers 320. In some embodiments, the key position of the user device 310 may be dynamic, in that, the key position may change as per preferences of the associated user. In some embodiments, the type of NFC transaction may refer to what NFC application 418 is being utilized to carry out an NFC transaction, such as, for vehicle cards, door cards, financial payments, transmit cards, and the like. In some embodiments, while carrying out a particular NFC transaction, the type of NFC transaction may be static for said particular NFC transaction.

In some embodiments, the NFC firmware information may include information associated with the user device, such as firmware of the user device, chipset information of the user device, and the like. In some embodiments, the geographic location may refer to a geographical region where the NFC transaction is being carried out, such as a country, a city, and/or a locality. In some embodiments, the NFC firmware information and the geographic region may be static for the user device 310.

In some embodiments, the one or more sensors 406 may be configured to sense the plurality of context parameters and provide signals to the processor 410 indicative of the plurality of context parameters. For instance, the gyroscope 406C may measure the movement of the user device 310, such as angular movement along one or more axes of the user device 310. Further, the accelerometer 406B may measure a rate of change in velocity during movement of the user device 310. The GPS sensor 406A may measure a location of the user device 310.

The readings and measurements from the one or more sensors 406 may be received by the processor 410. The processor 410 may be configured to extract the plurality of context parameters related to the NFC transaction to be performed from the received readings. In some embodiments, the processor 410 may be configured to extract the plurality of context parameters in conjunction with the context handler 506.

In some embodiments, the plurality of context parameters may be correlated with the plurality of RF configurations based on the AI model 416. The plurality of RF configurations may be stored in the configuration database 412C of the memory 412. In some embodiments, the configuration database 412C may be stored on the user device 310, and thus, the plurality of RF configurations may be stored on the user device 310. As described above, the plurality of RF configurations may be referred to as NFC antenna configurations.

In some embodiments, the AI model 416 may be generated to establish correlations of the plurality of context parameters with the plurality of RF configurations. In some embodiments, the AI model may be trained based on a learning technique which may be considered as a method for training a predetermined target device using a plurality of learning data to cause, allow, or control the target device to make a determination or prediction. Examples of learning techniques include, but are not limited to, supervised learning, unsupervised learning, semi-supervised learning, or reinforcement learning.

The AI model may include a plurality of neural network layers. Each layer may have a plurality of weight values, and may perform a layer operation using a calculation result of a previous layer and an operation of the plurality of weight values. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

In some embodiments, generating the AI model based on training means that a predefined operation rule or artificial intelligence model configured to perform a desired feature (or purpose) is obtained by training a basic artificial intelligence model with multiple pieces of training data by a training technique. The artificial intelligence model may include a plurality of neural network layers. Each of the plurality of neural network layers may include a plurality of weight values and may perform neural network computation by computation between a computation result of a previous layer and the plurality of weight values. The artificial intelligence model may perform neural network computation by computation based on the computation result of a previous layer (or first layer) and the plurality of weight values of current layer (second layer).

Reasoning prediction is a technique of logically reasoning and predicting by determining information and includes, e.g. knowledge-based reasoning, optimization prediction, preference-based planning, or recommendation.

In some embodiments, the AI model 416 may be trained to learn and establish the correlations of the plurality of context parameters with the plurality of RF configurations. In some embodiments, the AI model 416 may be trained based on training data comprising multiple combinations of predefined context parameters. For instance, different combinations of one or more of the orientation of the user device 310, the tap angle of the user device 310, the key position of the user device 310, the types of the NFC transactions, NFC firmware information, and geographic locations where the NFC transaction is to be performed may be used as training data.

Based on the training data, e.g. based on the multiple predefined context parameter combinations, a corresponding success rate for each of the plurality of RF configurations may be determined. The corresponding success rate may define, for a particular context parameter combination, probability of successful transaction when using the associated RF configuration. For instance, the plurality of RF configurations may include RF Config. 1, RF Config. 2, . . . RF Config. N. For a particular combination of predefined context parameters, say combination 1, the success rates may be determined as 70% for RF Config. 1, 50% for RF Config. 2, 45% for RF Config. N, etc. . . . . Similarly, for a different combination of predefined context parameters, say combination 2, the success rates may be determined as 30% for RF Config. 1, 90% for RF Config. 2, 50% for RF Config. N, etc . . . .

In some embodiments, a set of NFC transactions may be performed with various readers, such as readers 320, for the multiple predefined context parameter combinations. The NFC transactions may be performed for a predetermined number of iterations to determine the corresponding success rates associated with the plurality of RF configurations. In other words, for a particular combination of predefined context parameters, the NFC transactions may be performed based on RF Config. 1 for a predetermined number of iterations. The success rate of RF Config. 1 for the particular combination of context parameters may thus be determined. The NFC transactions may then be performed based on RF Config. 2, RF Config. 3, . . . RF Config. N in order to determine the corresponding success rates for each of the plurality of RF configurations.

Similarly, multiple other combinations of predefined context parameters may be used to determine the corresponding success rates of the plurality of RF configurations for each of the multiple other combinations of predefined context parameters. In some embodiments, the corresponding success rate may be determined based on the equation (1):

$$( \frac{number of successful transactions}{total number of transactions} ) * 100 \qquad ( 1 )$$

Accordingly, based on the multiple predefined context parameter combinations, and the corresponding success rates of each of the plurality of RF configurations for the multiple predefined context parameter combinations, a success matrix may be generated. The success matrix may define the correlations between the multiple predefined context parameter combinations and the plurality of RF configurations.

In some embodiments, the success matrix may be stored in a database, such as a database associated with the AI model 416 or a database associated with the memory 412. The success matrix may thus be referred to when an NFC transaction is being performed in real-time in order to select an optimal RF configuration for the NFC transaction, as described further below in the disclosure.

When an NFC transaction is to be performed, the processor 410 may be configured to receive readings from the one or more sensors 406 and extract the plurality of context parameters related to the NFC transaction from the received readings, in conjunction with the input feature handler 504 and the context handler 506.

The processor 410 may be configured to refer to the AI model 416 to select an optimal RF configuration from the plurality of RF configurations for executing the NFC transaction, in conjunction with the selection module 508. In some embodiments, the processor 410 may be configured to select the optimal RF configuration based on the established correlation between the plurality of context parameters and the plurality of RF configurations, for instance, by referring to the stored success matrix.

In some embodiments, the processor 410 may be configured to identify a combination of the extracted plurality of context parameters. The processor 410 may be configured to identify a relevant context parameter combination from the multiple predefined context parameter combinations of the success matrix. That is, the processor 410 may be configured to identify the combination of context parameters related to the NFC transaction to be performed that matches at least one of the stored multiple predefined context parameter combinations, the matched predefined context parameter combinations being the relevant context parameter combination.

Further, the processor 410 may be configured to identify the plurality of RF configurations and the associated success rates for the identified relevant context parameter combination. The processor 410 may be configured to determine from the success matrix, for the relevant context parameter combination, one RF configuration from the plurality of RF configurations having the highest success rate. The one RF configuration having the highest success rate may be determined as the optimal RF configuration to be used to carry out the NFC transaction.

Accordingly, the processor 410 in conjunction with the selection module 508 may be configured to select the optimal RF configuration based on the established correlation between the obtained plurality of context parameters and the plurality of RF configurations.

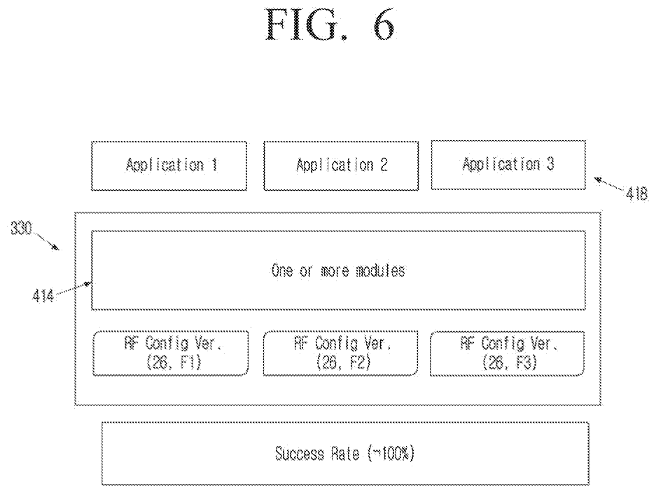

Once the optimal RF configuration is determined, the processor 410 may be configured to load the optimal RF configuration for executing the NFC transaction, in conjunction with the loading module 510. In some embodiments, the processor 410 in conjunction with the loading module 510 may have access to the plurality of RF configurations, as also shown in FIG. 5. In some embodiments, the processor 410 in conjunction with the loading module 510 may dynamically load the optimal RF configuration pre-emptively before the NFC transaction is carried out. Referring to FIG. 6, a schematic overview of the system 330 is illustrated in accordance with one or more embodiments of the disclosure. As seen in FIG. 6, the system 330 may be in communication with one or more NFC applications 418. When an NFC transaction is to be performed, the one or more modules 414 in conjunction with the processor 410, memory 412, and AI model 416 (see FIG. 4), process context parameters related to the NFC transaction and select the optimal RF configuration for carrying out the NFC transaction. As a result, a high success rate for the NFC transaction can be achieved as the optimal RF configuration is utilized for the NFC transaction.

As an example, for an NFC transaction for a first application (say, financial payment), the context parameters at the time of performing the NFC transaction may be measured, e.g. orientation=right, key position=right, tap angle=90 degrees, etc. . . . . Accordingly, the system 330 may identify the optimal RF configuration to be RF Config. 2 from the plurality of RF configurations, e.g., RF Config. 1, RF Config. 2, . . . RF Config. N. The NFC transaction may thus be successful.

In another example, for an NFC transaction for a second application (say, door key), the context parameters at the time of performing the NFC transaction may be measured, say, orientation=left, key position=right, tap angle=60 degrees, and the like. Accordingly, the system 330 may identify the optimal RF configuration to be RF Config. 1 from the plurality of RF configurations, e.g., RF Config. 1, RF Config. 2, . . . RF Config. N. The NFC transaction may thus be successful again for the second application.

In some embodiments, prior to referring to the AI model 416 to select the optimal RF configuration, the processor 410 may be configured to initiate execution of the NFC transaction based on a default RF configuration. The default RF configuration may be one RF configuration from among the plurality of RF configurations. The processor 410 may further be configured to determine, in conjunction with the transaction validator 502, a status of the NFC transaction, e.g., whether the NFC transaction has failed or was successful. In some embodiments, the processor 410 in conjunction with the transaction validator 502, may determine one or more failures of the NFC transaction executed based on the default RF configuration. In case the processor 410 determines that the NFC transaction is failing, the processor 410 may determine that a different RF configuration for executing the NFC transaction should be used. Accordingly, the processor 410 may select a better (or the optimal) RF configuration for the NFC transaction to be executed, and execute the NFC transaction using the optimal RF configuration. In some embodiments, the processor 410 may determine that a different RF configuration for executing the NFC transaction should be used when the NFC transaction based on the default RF configuration has failed for a predetermined number of attempts.

In some embodiments, the AI model 416 may be updated based on feedback information related to the executed NFC transactions. In some embodiments, the feedback information may comprise inferences related to success and failure information of the executed NFC transactions.

In some embodiments, the default RF configuration may be updated based on the feedback information and the updated AI model. Accordingly, the plurality of RF configurations may be personalized for the associated user of the user device 310. The performance and success of NFC transactions may thus be improved.

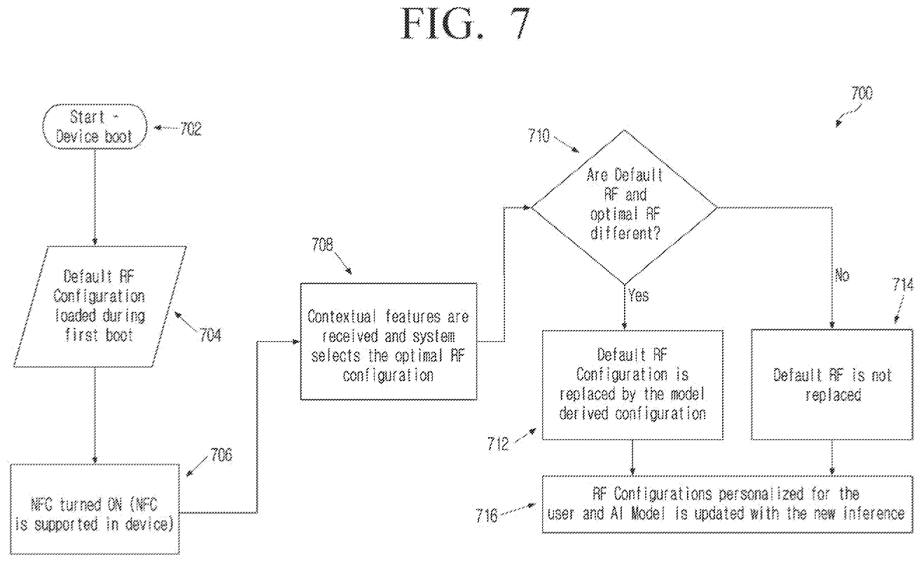

FIG. 7 illustrates a process flow 700 for selecting a model derived configuration, e.g., an optimal RF configuration during run time of the user device 310. The process starts at block 702 when the user device 310 is booted. At block 704, the default RF configuration may be loaded during the first boot. As described above, the default RF configuration may be a configuration from among the plurality of RF configurations.

At block 706, the NFC feature of the user device 310 may be turned ON, such that NFC would be supported by the user device 310. At block 708, the system 330, in particular the AI model 416 and the processor 410, receives the context parameters and processes the context parameters to select the optimal RF configuration, as described with reference to FIGS. 4-5.

At block 710, the processor 410 may check whether the optimal RF configuration determined based on the context parameters is the different from the default RF configuration. In case the optimal RF configuration determined based on the context parameters is different from the default RF configuration, at block 712 the optimal RF configuration is loaded to replace the default RF configuration.

In case the optimal RF configuration determined based on the context parameters is the same as the default RF configuration, at block 714 the default RF configuration is not replaced. The selected RF configuration, either the optimal RF configuration or the default RF configuration, may then be used for future NFC transactions. Further, at step 716, the AI model 416 may be updated based on feedback information, e.g. based on inferences when NFC transactions are carried out. The plurality of RF configurations are thus personalized for the associated user. In some embodiments, the plurality of RF configurations are personalized during runtime.

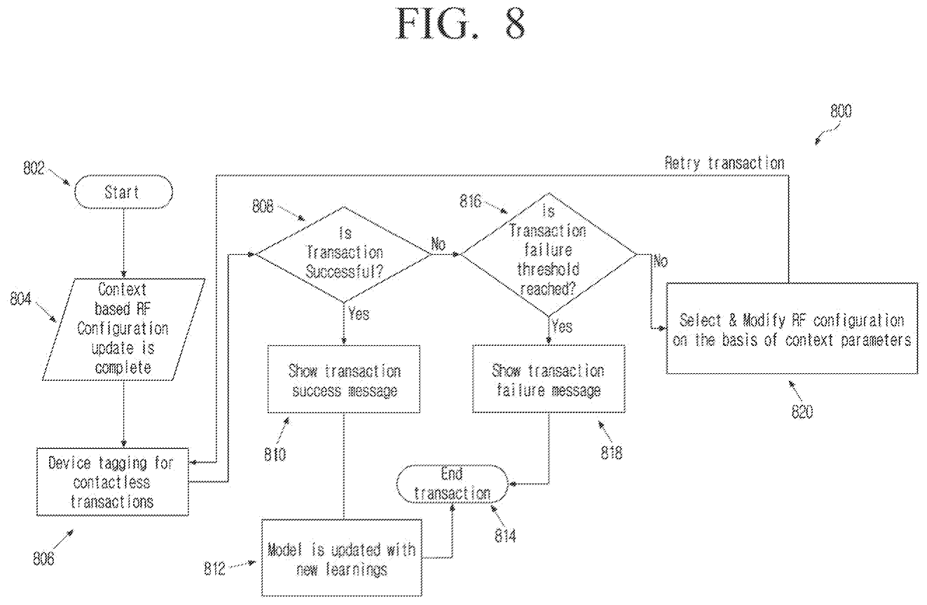

FIG. 8 illustrates a process flow 800 for executing an NFC transaction with a user device 310 in real time. The process starts at block 802. At block 804, the context-based RF configuration update is complete. In some embodiments, the context-based RF configuration update may include loading of the default RF configuration. In some embodiments, the context-based RF configuration update may include loading of an RF configuration from a previous transaction. At block 806, the associated user may tag the user device 310 with a reader, such as readers 320, to carry out contactless NFC transaction. As described above, transactions may include payments, pairings, data transfers, and the like.

At block 808, it is determined whether the NFC transaction is successful. If the NFC transaction is successful, at block 810, a transaction success message may be displayed on the user device 310, e.g. on a user interface of the user device 310. Further, at block 812, the AI model 416 may be updated based on the successful transaction to better personalize the RF configurations. The current NFC transaction may then end at block 814.

In case the NFC transaction is not successful at block 808, then at block 816, it is determined whether the NFC transaction has failed for a predetermined number of executions, e.g. whether a transaction failure threshold has been reached. In case the transaction failure threshold has been reached, a transaction failure message may be displayed at block 818 on the user device 310, e.g. on a user interface of the user device 310. The NFC transaction may then end at block 814.

In case the transaction failure threshold has been reached, at block 820, an optimal RF configuration is selected and loaded based on context parameters, as described with reference to FIGS. 4-5. In case the NFC transaction remains unsuccessful, the transaction process may repeat from step 806. The transaction process may be repeated till the transaction failure threshold has been reached, after which the transaction failure message may be displayed as mentioned with reference to block 818.

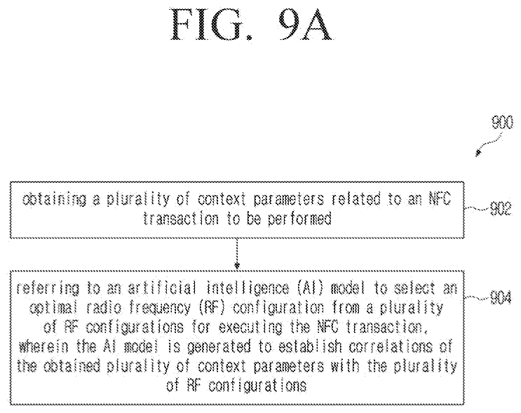

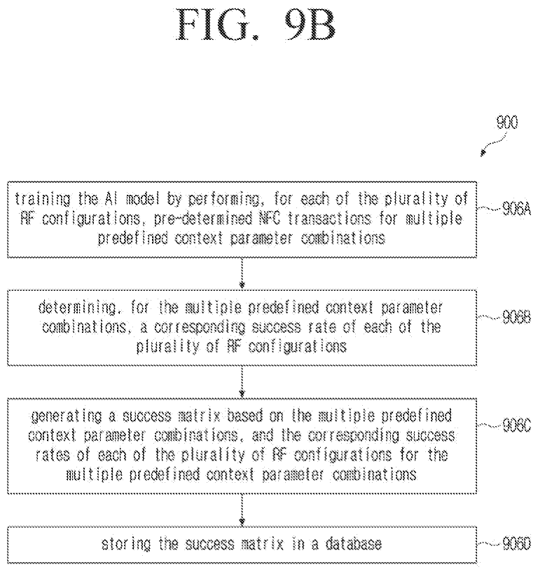

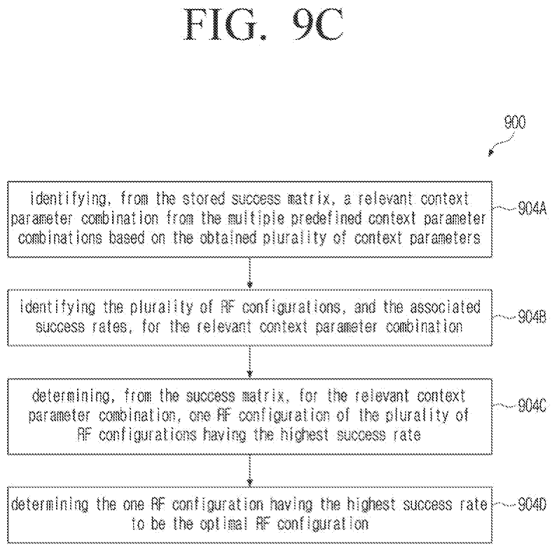

FIG. 9A illustrates an example process flow comprising a method 900 for executing NFC transactions using the user device 310, according to one or more embodiments of the disclosure. In at least one embodiment, the steps of the method 900 may be performed by the system 330, as discussed above.

At step 902, the method 900 comprises obtaining a plurality of context parameters related to an NFC transaction to be performed. In some embodiments, the plurality of context parameters comprise one or more of the orientation of the user device, the tap angle with respect to an NFC reader, the key position of the user device, the type of the NFC transaction to be performed, NFC firmware information, and the geographic location of the NFC transaction to be performed.

In some embodiments, the method may further comprise receiving readings indicative of values of corresponding context parameters of the plurality of context parameters, from one or more sensors at the user device. In some embodiments, the method may further comprise extracting the plurality of context parameters related to the NFC transaction to be performed, based on the received readings.

At step 904, the method 900 comprises referring to the AI model 416 to select the optimal RF configuration from the plurality of RF configurations for executing the NFC transaction. The AI model may be generated (or configured) to establish correlations of the obtained plurality of context parameters with the plurality of RF configurations. In some embodiments, the plurality of RF configurations are pre-stored on the user device 310. In some embodiments, each of the plurality of RF configurations comprises a corresponding NFC antenna configuration. In some embodiments, each of the corresponding NFC antenna configurations is associated with one or more of radio frequency parameters, impedance parameters, NFC firmware information, and hardware configuration parameters of the user device.

In some embodiments, the method 900 may further comprise selecting, based on the established correlation between the obtained plurality of context parameters and the plurality of RF configurations, the optimal RF configuration from the plurality of RF configurations.

In some embodiments, the method 900 may further comprise loading the optimal RF configuration for executing the NFC transaction.

In some embodiments, the method 900 may further comprise updating the AI model based on feedback information comprising inferences related to success and failure information associated with the executed NFC transaction.

In some embodiments, the method 900 may further comprise updating the default RF configuration based on the feedback information and the updated AI model. The plurality of RF configurations for a user associated with the user device may thus be personalized.

In some embodiments, the method 900 may further comprise initiating execution of the NFC transaction based on a default RF configuration of the user device. In some embodiments, the method may further comprise determining one or more failures of the NFC transaction executed based on the default RF configuration, and further, determining that a different RF configuration for executing the NFC transaction should be used.

In some embodiments, the method 900 may further comprise steps 906A-906D for training the AI model 416, as is depicted in FIG. 9B, according to one or more embodiments of the disclosure. In at least one embodiment, the steps of the method 900 depicted in FIG. 9B may be performed by the system 330, as discussed above. In some embodiments, the steps 906A-906D may be performed prior to step 902 or prior to step 904 depicted in FIG. 9A.

At step 906A, the method 900 comprises training the AI model by performing, for each of the plurality of RF configurations, pre-determined NFC transactions for multiple predefined context parameter combinations. At step 906B, the method 900 comprises determining, for the multiple predefined context parameter combinations, a corresponding success rate of each of the plurality of RF configurations.

At step 906C, the method 900 comprises generating a success matrix based on the multiple predefined context parameter combinations, and the corresponding success rates of each of the plurality of RF configurations for the multiple predefined context parameter combinations. At step 906D, the method 900 comprises storing the success matrix in a database.

In some embodiments, the method 900 may comprise steps 904A-904D for selecting the optimal RF configuration by referring to the trained AI model 416, as depicted in FIG. 9C, according to one or more embodiments of the disclosure. In at least one embodiment, the steps of the method 900 depicted in FIG. 9C may be performed by the system 330, as discussed above. In some embodiments, the steps 904A-904D may form sub-steps of the step 904 depicted in FIG. 9A.

At step 904A, the method 900 comprises identifying, from the stored success matrix, a relevant context parameter combination from the multiple predefined context parameter combinations based on the obtained plurality of context parameters. At step 904B, the method 900 comprises identifying the plurality of RF configurations, and the associated success rates, for the relevant context parameter combination.

At step 904C, the method 900 comprises determining, from the success matrix, for the relevant context parameter combination, one RF configuration of the plurality of RF configurations having the highest success rate. At step 904D, the method 900 comprises determining the one RF configuration having the highest success rate to be the optimal RF configuration.

While the above discussed steps in FIGS. 9A-9C are shown and described in a particular sequence, the steps may occur in variations to the sequence in accordance with various embodiments. Further, a detailed description related to the various steps of FIGS. 9A-9C is already covered in the description related to FIGS. 3-5 and is omitted herein for the sake of brevity.

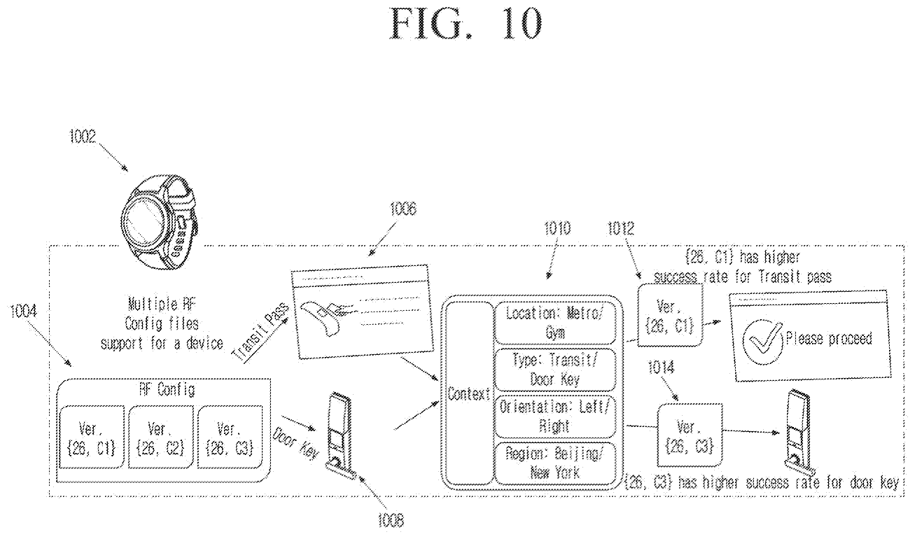

FIG. 10 illustrates an example use case for executing NFC transactions based on context-based reconfigurable RF configurations. As seen in FIG. 10, the user device 1002 (analogous to user device 310) may be associated with a plurality of RF configurations 1004, such as, RF ver. (26, C1), RF ver. (26, C2), RF ver. (26, C3), and the like. The user device 1002 may be used for transit pass application 1006 as well as for door key application 1008. Based on the context parameters, the optimal RF configuration may be determined by the system 1010 (analogous to system 330) for each application, e.g. for the transit pass application 1006 and the door key application 1008. The context parameters may include, for instance, location (metro, gym, etc.), type of transaction (transit, door key, etc.), orientation (left or right), region (country 1, country 2, etc.). The optimal RF configuration 1012 (e.g. RF ver. (26, C1)) for the transit pass application 1006 may be selected by the system 1010 and the NFC transaction may be successfully executed based on the optimal RF configuration 1012. Further, the optimal RF configuration 1014 (e.g. RF ver. (26, C3)) for the door key application 1008 may be selected by the system 1010 and the NFC transaction may be successfully executed based on the optimal RF configuration 1014. Thus, even with various applications, there is no failure of NFC transactions as the RF configuration having the highest success rates would be utilized.

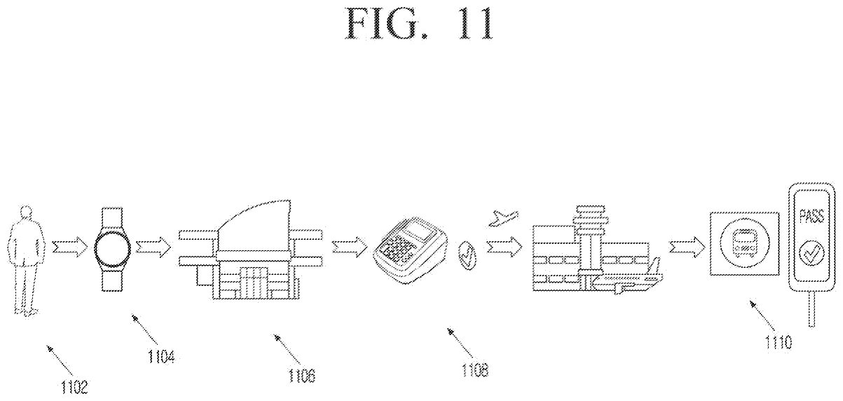

FIG. 11 illustrates another example use case for executing NFC transactions based on context-based reconfigurable RF configurations. As seen in FIG. 11, a user 1102 may purchase a device 1104 (analogous to user device 310) in a first geographical region. The user 1102 may go to an establishment 1106 and carry out an NFC transaction at a POS reader 1108 in the establishment 1106 within the first geographical region. Further, the user 1102 may travel to a second geographical region and carry out another NFC transaction using the device 1104, such as, payment for a transit pass 1110 in the second geographical region. The NFC transaction in the second geographical region may be successfully executed as the optimal RF configuration would be utilized based on the context parameters, such as, geographical region.

The disclosure provides for various technical advancements based on the key features discussed above. The disclosure provides systems and methods that enable context-based selection of an optimal RF configuration for executing NFC transactions. The RF configurations are changed dynamically to make an ongoing NFC transaction a success, without user intervention. Accordingly, failure rates of NFC transactions are reduced and user experience while performing NFC transactions is improved.

The systems and methods described herein allow successful transactions with various types of readers, and in different geographical regions. The user carrying out the NFC transaction may not worry about hand positions and tap angles, and the system described herein automatically selects the optimal RF configuration based on the context parameters. The user can thus wear the device as per their preference without worrying about NFC transaction being unsuccessful. Moreover, the systems and methods facilitate personalizing the RF configurations, such as in runtime, based on NFC transactions being executed, further enhancing the success rates and user experience.

While specific language has been used to describe the present subject matter, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

FIG. 12 illustrates various use cases for executing NFC transactions based on context-based reconfigurable RF configurations, according to one or more embodiments of the disclosure.

A method of controlling an electronic device executing near-field communication (NFC) transactions, the method comprising, obtaining a plurality of context parameters related to an NFC transaction to be performed (S1205), and identifying (or selecting) an optimal radio frequency (RF) configuration from a plurality of RF configurations for executing the NFC transaction by inputting the plurality of context parameters into an artificial intelligence (AI) model (S1210), wherein the AI model may be an AI model for establishing correlations of the plurality of context parameters with the plurality of RF configurations.

The electronic device may be described as the user device (310).

The electronic device may communicate with external device by using the NFC communication method. The transaction may be described as transmission or process. The NFC transaction may include exchanging data (or information).

The context parameter may be described as parameter or context information. The context parameter may be described as communication environment information or communication environment parameter.

The optimal RF configuration may be described as recommended RF configuration or target RF configuration. The optimal RF configuration may be the described final RF configuration.

The identifying the optimal RF configuration may be described as “referring (step 904) to an artificial intelligence (AI) model (416) to identify the optimal RF configuration.”

After obtaining the plurality of context parameters, the electronic device may input the plurality of context parameters into the AI model. In addition, the electronic device may obtain the optimal RF configuration as output data of the AI model.

For one example, the AI model may be stored in the electronic device.

For one example, the AI model may be stored in an external server. The electronic device may transmit the plurality of context parameters to the external server. The external server may obtain the optimal RF configuration by using the AI model stored in the external server. The electronic device may receive the optimal RF configuration corresponding to the plurality of context parameters from the external server.

The AI model may establish (or obtain or identify) correlations based on the plurality of context parameters and the plurality of RF configurations. The AI model may obtain the correlations corresponding to the plurality of context parameters. The AI model may obtain the optimal RF configuration among the plurality of RF configurations based on the established correlations.

The plurality of RF configurations may be pre-stored on the electronic device.

For one example, the electronic device may store the plurality of RF configurations. The AI model stored in the electronic device may use the plurality of RF configurations.

For one example, the external server may store the plurality of RF configurations. The AI model stored in the external server may use the plurality of RF configurations.

The identifying the optimal RF configuration comprises, identifying (or selecting) the optimal RF configuration from the plurality of RF configurations based on the established correlation between the plurality of context parameters and the plurality of RF configurations. The method may further comprise loading the optimal RF configuration for executing the NFC transaction.

The electronic device may obtain the established correlation based on the plurality of context parameters and the plurality of RF configurations.

For example, the plurality of RF configurations include a first RF configuration and a second RF configuration. The electronic device may obtain a first correlation between the plurality of context parameters and the first RF configuration. The electronic device may obtain a second correlation between the plurality of context parameters and the second RF configuration. The electronic device may identify (or obtain or determine) the established correlation (or final correlation) among the first correlation and the second correlation.

The obtaining the plurality of context parameters may comprise receiving, from one or more sensors at the electronic device, readings indicative of values of corresponding context parameters of the plurality of context parameters, and obtaining (or extracting) the plurality of context parameters related to the NFC transaction to be performed based on the received readings.

The readings may be described as sensing data or sensing information. The readings may be described as values of context parameter. The readings may include a value corresponding to each of the plurality of context parameters. The readings may include quantifiable values for context parameters.

The plurality of context parameters may comprise one or more of an orientation of the electronic device, a tap angle with respect to an NFC reader, a key position of the electronic device, a type of the NFC transaction to be performed, NFC firmware information, and a geographic location of the NFC transaction to be performed.

Prior to the identifying (or selecting) the optimal RF configuration, the method may further comprise performing, initiating execution of the NFC transaction based on a default RF configuration of the electronic device, determining one or more failures of the NFC transaction executed based on the default RF configuration, and determining that a different RF configuration for executing the NFC transaction is required.

The method may further comprise training the AI model by performing, for each of the plurality of RF configurations, pre-determined NFC transactions for multiple predefined context parameter combinations, determining, for the multiple predefined context parameter combinations, a corresponding success rate of each of the plurality of RF configurations, generating a success matrix based on the multiple predefined context parameter combinations, and the corresponding success rates of each of the plurality of RF configurations for the multiple predefined context parameter combinations, and storing the success matrix in a database.

For at least one example, the database may be on the electronic device.

For at least one example, the database may be on the external server.

The identifying (or selecting) the optimal RF configuration comprises, identifying, from the stored success matrix, a relevant context parameter combination from the multiple predefined context parameter combinations based on the plurality of context parameters, identifying the plurality of RF configurations, and the associated success rates, for the relevant context parameter combination, determining, from the success matrix, for the relevant context parameter combination, one RF configuration of the plurality of RF configurations having the highest success rate, and determining the one RF configuration having the highest success rate to be the optimal RF configuration.

The method may further comprise updating the AI model based on feedback information, the feedback information comprising inferences related to success and failure information associated with the executed NFC transaction, and updating the default RF configuration based on the feedback information and the updated AI model, thereby personalizing the plurality of RF configurations for a user associated with the electronic device.

The electronic device may be a wearable device. Each of the plurality of RF configurations comprises a corresponding NFC antenna configuration. Each of the corresponding NFC antenna configuration may be associated with one or more of radio frequency parameters, impedance parameters, NFC firmware information, and hardware configuration parameters of the electronic device.

While certain example embodiments the disclosure have been particularly shown and described, it will be understood that various changes in form and details may be made therein without departing from the spirit and scope of the following claims.

What is claimed is:

1. A method of controlling an electronic device executing near-field communication (NFC) transactions, the method comprising:
obtaining a plurality of context parameters related to an NFC transaction to be performed;
identifying an optimal radio frequency (RF) configuration from a plurality of RF configurations for executing the NFC transaction by inputting the plurality of context parameters into an artificial intelligence (AI) model; and
executing the NFC transaction using the optimal RF configuration,
wherein the AI model is configured to establish correlations of the plurality of context parameters with the plurality of RF configurations, and
wherein the plurality of context parameters comprises one or more of:
an orientation of the electronic device, a tap angle with respect to an NFC reader, a key position of the electronic device, a type of the NFC transaction to be performed, NFC firmware information, and a geographic location of the NFC transaction to be performed.

2. The method as claimed in claim 1,
wherein the electronic device is a wearable device,
wherein each of the plurality of RF configurations comprises a corresponding NFC antenna configuration, and
wherein each of the corresponding NFC antenna configuration is associated with one or more of radio frequency parameters, impedance parameters, NFC firmware information, and hardware configuration parameters of the electronic device.

3. The method as claimed in claim 1, wherein the plurality of RF configurations are pre-stored on the electronic device.

4. The method of claim 1,
wherein the identifying the optimal RF configuration comprises:
identifying the optimal RF configuration from the plurality of RF configurations based on the correlations between the plurality of context parameters and the plurality of RF configurations, and
wherein the method further comprises:
loading the optimal RF configuration for executing the NFC transaction.

5. The method as claimed in claim 1, wherein the obtaining the plurality of context parameters comprises:
receiving, from one or more sensors at the electronic device, readings indicative of values of corresponding context parameters of the plurality of context parameters; and
obtaining the plurality of context parameters related to the NFC transaction to be performed based on the readings.

6. The method as claimed in claim 1, further comprising, prior to the identifying the optimal RF configuration:
initiating execution of the NFC transaction based on a default RF configuration of the electronic device;
determining one or more failures of the NFC transaction executed based on the default RF configuration; and
determining that a different RF configuration for executing the NFC transaction should be used.

7. The method as claimed in claim 1, further comprising:
training the AI model by performing, for each of the plurality of RF configurations, pre-determined NFC transactions for multiple predefined context parameter combinations;
determining, for the multiple predefined context parameter combinations, corresponding success rates of each of the plurality of RF configurations, respectively;
generating a success matrix based on the multiple predefined context parameter combinations, and the corresponding success rates of each of the plurality of RF configurations for the multiple predefined context parameter combinations; and
storing the success matrix in a database.

8. The method as claimed in claim 7, wherein the identifying the optimal RF configuration comprises:
identifying, from the success matrix, a relevant context parameter combination from the multiple predefined context parameter combinations based on the plurality of context parameters,
identifying the plurality of RF configurations, and the corresponding success rates, for the relevant context parameter combination,
determining, from the success matrix, for the relevant context parameter combination, one RF configuration of the plurality of RF configurations having a highest success rate, and
determining the one RF configuration having the highest success rate to be the optimal RF configuration.

9. The method as claimed in claim 6, further comprising:
obtaining an updated AI model by updating the AI model based on feedback information, the feedback information comprising inferences related to success and failure information associated with the NFC transaction; and
updating the default RF configuration based on the feedback information and the updated AI model, thereby personalizing the plurality of RF configurations for a user associated with the electronic device.

10. The method as claimed in claim 1, wherein the AI model includes a plurality of neural network layers,
wherein each of the plurality of neural network layers includes a plurality of weight values, and
wherein the method further comprising performing neural network computation by computation based on a computation result of a previous layer and a plurality of weight values of a current layer.

11. An electronic device executing near-field communication (NFC) transactions comprising:
at least one memory storing instructions; and
at least one processor connected to the at least one memory and configured to execute the instructions to:
obtain a plurality of context parameters related to an NFC transaction to be performed;
identify an optimal radio frequency (RF) configuration from a plurality of RF configurations for executing the NFC transaction by inputting the plurality of context parameters into an artificial intelligence (AI) model; and
execute the NFC transaction using the optimal RF configuration,
wherein the AI model is configured to establish correlations of the plurality of context parameters with the plurality of RF configurations, and
wherein the plurality of context parameters comprises one or more of:
an orientation of the electronic device, a tap angle with respect to an NFC reader, a key position of the electronic device, a type of the NFC transaction to be performed, NFC firmware information, and a geographic location of the NFC transaction to be performed.

12. The electronic device as claimed in claim 11,
wherein the electronic device is a wearable device,
wherein each of the plurality of RF configurations comprises a corresponding NFC antenna configuration, and
wherein each of the corresponding NFC antenna configuration is associated with one or more of radio frequency parameters, impedance parameters, NFC firmware information, and hardware configuration parameters of the electronic device.

13. The electronic device as claimed in claim 11, wherein the plurality of RF configurations are pre-stored on the electronic device.

14. The electronic device as claimed in claim 11, wherein the at least one processor is further configured to execute the instructions to:
identify the optimal RF configuration from the plurality of RF configurations based on the correlations between the plurality of context parameters and the plurality of RF configurations, and
load the optimal RF configuration for executing the NFC transaction.

15. The electronic device as claimed in claim 11, wherein the at least one processor is further configured to execute the instructions to:
receive, from one or more sensors at the electronic device, readings indicative of values of corresponding context parameters of the plurality of context parameters; and
obtain the plurality of context parameters related to the NFC transaction to be performed based on the readings.

16. The electronic device as claimed in claim 11, wherein the at least one processor is further configured to execute the instructions to, prior to the identifying the optimal RF configuration:
initiate execution of the NFC transaction based on a default RF configuration of the electronic device;
determine one or more failures of the NFC transaction executed based on the default RF configuration; and
determine that a different RF configuration for executing the NFC transaction should be used.

17. The electronic device as claimed in claim 11, wherein the at least one processor is further configured to execute the instructions to:
train the AI model by performing, for each of the plurality of RF configurations, pre-determined NFC transactions for multiple predefined context parameter combinations;
determine, for the multiple predefined context parameter combinations, corresponding success rates of each of the plurality of RF configurations, respectively;
generate a success matrix based on the multiple predefined context parameter combinations, and the corresponding success rates of each of the plurality of RF configurations for the multiple predefined context parameter combinations; and
store the success matrix in a database in the at least one memory.

18. The electronic device as claimed in claim 17, wherein the at least one processor is further configured to execute the instructions to identify the optimal RF configuration by:
identifying, from the success matrix, a relevant context parameter combination from the multiple predefined context parameter combinations based on the plurality of context parameters,
identifying the plurality of RF configurations, and the corresponding success rates, for the relevant context parameter combination,
determining, from the success matrix, for the relevant context parameter combination, one RF configuration of the plurality of RF configurations having a highest success rate, and
determining the one RF configuration having the highest success rate to be the optimal RF configuration.

19. The electronic device as claimed in claim 16, wherein the at least one processor is further configured to execute the instructions to:
obtain an updated AI model by updating the AI model based on feedback information, the feedback information comprising inferences related to success and failure information associated with the NFC transaction; and
update the default RF configuration based on the feedback information and the updated AI model, thereby personalizing the plurality of RF configurations for a user associated with the electronic device.

20. The electronic device as claimed in claim 16,
wherein the AI model includes a plurality of neural network layers,
wherein each of the plurality of neural network layers includes a plurality of weight values, and
wherein the at least one processor is further configured to execute the instructions to:
perform neural network computation by computation based on a computation result of a previous layer and a plurality of weight values of a current layer.
